(19) United States
(12) Patent Application Publication
(10) Pub. No.: US 2005/0223558 A1
(43) Pub. Date: Oct. 13, 2005

(54) Rolling bearing unit with encoder and manufacturing method thereof

(76) Inventor: Junshi Sakamoto, Fujisawa-shi (JP)

Correspondence Address: KATTEN MUCHIN ROSENMAN LLP, 575 MADISON AVENUE, NEW YORK, NY, 10022-2585, US

(21) Appl. No.: 11/135,822

(22) Filed: May 24, 2005

Related U.S. Application Data
(63) Continuation of application No. PCT/JP04/03486, filed on Mar. 16, 2004.

(30) Foreign Application Priority Data
Mar. 26, 2003 (JP) 2003-084745

(51) Int. Cl. F16C 32/00; F16C 41/04

(52) U.S. Cl. 29/898.14

(57) ABSTRACT

In order to detect the rotational speed of a wheel secured to a rolling bearing unir 2a with high accuracy, an encoder 19a secured to an outer peripheral surface of an inside end of an inner ring 6a is formed from a Fe—Cr—Co magnet. As a result, the magnetic properties do not become uneven depending on the position on the encoder 19a, and the rotational speed of the wheel can be detected with high accuracy.

### TECHNICAL FIELD

The present invention relates to a rolling bearing unit with an encoder, and a manufacturing method thereof, which is used to rotatably support an automobile wheel with respect to a suspension system, and to detect the rotational speed of the wheel by combining with a rotation detecting sensor for detecting rotational speed.

### BACKGROUND ART

There is a rolling bearing unit with a rotational speed detecting sensor, which is constructed by combining a rolling bearing unit with an encoder, and a rotation detecting sensor for detecting rotational speed installed in a stationary part such as a cover connected to an outer ring.

The rolling bearing unit is used to rotatably support an automobile wheel with respect to a suspension system. Moreover, in order to control an antilock brake system (ABS) or a traction control system (TCS) it is necessary to detect the rotational speed of the wheel. Therefore, a method has been widely used recently where the wheel is rotatably supported with respect to the suspension system, and the rotational speed of the wheel is detected, by using the rolling bearing unit with a rotational speed detector which a rotational speed detector is incorporated into the rolling bearing unit.

As the rolling bearing unit with a rotational speed detector used for such a purpose, for example a construction as shown in FIG. 26 is described in Japanese Unexamined Patent Publication No. Hei 11-23596. The rolling bearing unit with a rotational speed detector 1 of the conventional construction shown in FIG. 26 comprises a rotational speed detector 3 incorporated into a rolling bearing unit 2. The rolling bearing unit 2 comprises a hub 5 and an inner ring 6 which constitute an inner ring unit, rotatably supported on the inner diameter side of an outer ring 4 concentric with the outer ring 4. In the example in the figure, the hub 5 and the inner ring 6 constitute the inner ring unit, and become a rotation member. A first flange 7 for attaching a wheel is provided on the outer peripheral surface of the outside end portion of the hub 5 (“outside” in the axial direction means the side towards the widthwise outside when assembled in the vehicle; the left side in the respective drawings except for FIG. 2 to FIG. 4, FIG. 17, and FIG. 18, while conversely, the side towards the widthwise center when assembled in the vehicle; the right side in the respective drawings except for FIG. 2 to FIG. 4, FIG. 17, and FIG. 18, is deemed “inside”; this is the same throughout the present description). A first inner ring raceway 8 is provided on the outer peripheral surface of the middle portion of the hub 5. This first inner ring raceway 8 may be provided integrally with the hub in some cases, or it may be provided on the outer peripheral surface of an inner ring which is separate from the hub in other cases.

Moreover, the inner ring 6 has a second inner ring raceway 9 on the outer peripheral surface, and is externally fitted to a step portion 10 which is formed on the inside end side of the hub 5 and has a smaller outer diameter than the portion where the first inner ring raceway 8 is provided. Moreover, a first outer ring raceway 11 facing the first inner ring raceway 8 and a second outer ring raceway 12 facing the second inner ring raceway 9 are formed on the inner peripheral surface of the outer ring 4. A second flange 13 for supporting the outer ring 4 on the suspension system is formed on the outer peripheral surface of the outer ring 4. Furthermore, a plurality of rolling elements 14 are provided respectively between the first inner ring raceway 8 and the second inner ring raceway 9, and between the first inner ring raceway 11 and the second outer ring raceway 12, so that the hub 5 and the inner ring 6 are rotatably supported on the inner diameter side of the outer ring 4. In a condition with the inner ring 6 externally fitted to the step portion 10, a nut 15 is screwed onto a male screw portion formed on the inside end of the hub 5, to press against the inner ring 6, so as to keep the inner ring 6 and the hub 5 from being separated.

Moreover, the inside end opening of the outer ring 4 is closed by a cover 16. The cover 16 comprises a bottomed cylindrical main body 17 which is formed from a synthetic resin by injection molding, and a fitting cylinder 18 which is connected to the opening portion of the main body 17. This fitting cylinder 18 is connected to the opening of the main body 17 by molding its base end portion when injection molding the main body 17. The cover 16 constituted in this manner closes up the inside end opening of the outer ring 4, by externally securing the tip half portion of the fitting cylinder 18 (left half in FIG. 26) to the inside end of the outer ring 4, by interference fit.

On the other hand, in order to constitute the rotational speed detector 3, an encoder 19 is externally secured through a slinger 20 to a portion away from the second inner ring raceway 9, at the outer peripheral surface of the inside end of the inner ring 6 which is externally secured to the inside end of the hub 5. The slinger 20 is formed into an overall annular shape of L-shape in cross-section, by bending a magnetic metal plate of a carbon steel plate such as SPCC or the like, and is externally secured to the inside end of the inner ring 6 by interference fit. Moreover, the encoder 19 is made by forming a permanent magnet made from a rubber mixed with ferrite powder, into an annular shape, and is bonded onto the inside surface of the annular portion constituting the slinger 20 by baking or the like. Forming the encoder from such a permanent magnet made from rubber, is heretofore widely known, as described for example in Japanese Unexamined Patent Publication No. Hei 9-203415. The encoder 19 is magnetized for example in the axial direction (left and right direction in FIG. 26), and the magnetization direction is changed alternately at equal intervals around the circumferential direction. Therefore, south poles and north poles are arranged alternately at equal intervals around the circumferential direction on the inside surface of the encoder 19, being the surface to be detected.

Moreover, an insertion hole 21 is formed in a part of the main body 17 which constitutes the cover 16, in a portion facing the inside surface of the encoder 19, piercing the main body 17 along the axial direction of the outer ring 4. A rotation detecting sensor 22 (including a rotation detecting sensor unit comprising a detecting element or the like embedded in a synthetic resin; this is the same throughout the present description) is inserted into the insertion hole 21. The rotation detecting sensor 22 comprises embedded in a synthetic resin: an IC which incorporates a magnetic detecting element such as a hall element, or a magnetoresistance element (MR element) for which the output changes according to the flow direction of the magnetic flux, and a waveform shaping circuit for shaping the output waveform from the magnetic detecting element; and a pole piece made from a magnetic material for guiding the magnetic flux flowing out from the encoder 19 (or flowing into the encoder 19), to the magnetic detecting element.

Such a rotation detecting sensor 22 comprises: a columnar insertion portion 23 provided towards the tip end (left end in FIG. 26), which can be inserted into the insertion hole 21 without play; and a brim 24 in the shape of an outward flange, formed on the base end (right end in FIG. 26) of the insertion portion 23. An engagement groove is formed in the outer peripheral surface of the middle portion of the insertion portion 23, and an O-ring 25 is engaged in this engagement groove.

On the other hand, an engagement cylinder 27 is provided on a part of the outside surface of the cover 16 (on the side face on the opposite side to a space 26 provided with the rolling elements 14, which is to be closed by the cover 16; the right side face in FIG. 26), on a portion surrounding the opening of the insertion hole 21. In a condition with the insertion portion 23 inserted into the engagement cylinder 27 and the brim 24 abutted against the tip end surface of the engagement cylinder 27, the rotation detecting sensor 22 is connected to and supported on the engagement cylinder 27 using an engagement spring 28. Such connection and support structure by using the engagement spring 28 is described in detail in Japanese Unexamined Patent Publication No. Hei 11-23596, and is not related to the gist of the present invention. Therefore, detailed illustration and description are omitted.

When using the aforementioned rolling bearing unit with a rotational speed detector 1, the second flange 13 set on the outer peripheral surface on the outer ring 4 is connected and fixed to the suspension system by bolts (not shown), and the wheel is fixed to the first flange 7 set on the outer peripheral surface of the hub 5, by studs 29 provided on this first flange 7, so that the wheel is rotatably supported on the suspension system. When the wheel is rotated in this condition, the north poles and south poles existing on the inside surface of the encoder 19 alternately pass through the vicinity of the end surface, being the detection surface, of the rotation detecting sensor 22. As a result, the direction of the magnetic flux flowing within the rotation detecting sensor 22 is changed, so that the output from the rotation detecting sensor 22 is changed. The frequency of the output from the rotation detecting sensor 22 being changed in this manner, is proportional to the rotational speed of the wheel. Consequently, if the output from this rotation detecting sensor 22 is sent to a controller (not shown), an ABS or TCS can be suitably controlled.

Recently, it is required to control the ABS or TCS more accurately in order to increase the safety of an automobile. For this purpose, it is needed to detect the rotational speed of the wheel with high accuracy. However, if an encoder made from a rubber magnet is used to detect the rotational speed, it is difficult to detect the rotational speed with high accuracy (ensuring sufficient reliability). That is, although the encoder made from a rubber magnet is made into a permanent magnet by magnetizing a substrate in which rubber is mixed with ferrite powder, it is difficult to evenly distribute the ferrite throughout the rubber, so that it is not possible to completely prevent the magnetic properties from being somewhat uneven depending on the position on the rubber magnet. Consequently, an accurate waveform of the magnetic flux variation can not be obtained if an encoder made from a rubber magnet is used. Therefore, it is difficult to detect the rotational speed with high accuracy by an encoder made from a rubber magnet.

The rolling bearing unit with an encoder and the manufacturing method thereof of the present invention take the above problems into consideration, with an object of realizing a structure which enables detection of the rotational speed of a wheel with high accuracy (ensuring sufficient reliability).

### DISCLOSURE OF THE INVENTION

A rolling bearing unit with an encoder according to the present invention comprises: an outer ring which has a double-row outer ring raceway on an inner peripheral surface; an inner ring unit which has a double-row inner ring raceway on an outer peripheral surface, and is arranged concentric with the outer ring on the inner diameter side of the outer ring; a plurality of rolling elements which are rotatably provided respectively between the inner ring raceway and the outer ring raceway; and an encoder which is secured to a rotating member, being a bearing ring member of one of the outer ring and the inner ring unit which rotates during use, on which north poles and south poles are arranged alternately around the circumferential direction, and said encoder is formed from a metal magnet.

Preferably the encoder is formed in an annular shape, and a magnetization direction of the encoder is perpendicular to a side face.

Preferably a peripheral rim of the encoder is fitted to a step portion formed on an inside end of the rotating member, and a part on an outside face of the encoder near the peripheral rim on the rotating member side is contacted with a step face which connects between the step portion and a peripheral surface existing axially outside from the step portion, so that the encoder is thereby secured to the rotating member.

Preferably a part of the encoder at the peripheral rim on the rotating member side, in contact with the rotating member is not magnetized.

Preferably the rotating member is the inner ring unit, and there is provided a slinger comprising a cylinder portion, and an annular portion formed by bending the end portion of the cylinder portion radially outward, and the cylinder portion is externally fitted to an outer peripheral surface of the inside end of the inner ring unit, and the encoder is bonded onto an inside surface of the annular portion.

Preferably the slinger has an outer cylinder portion which is bent axially inward from the outer peripheral rim of the annular portion, and an outer peripheral rim of the encoder is contacted with or adjacently opposed to an inner peripheral surface of the outer cylinder portion.

Preferably the whole circumference or a plurality of parts around the circumferential direction of the axial inside end of the outer cylinder portion is crimped radially inwards, so that the outer peripheral rim of the encoder is secured to the slinger.

Preferably the metal magnet is a Fe—Cr—Co magnet.

In the manufacturing method of a rolling bearing unit with an encoder according to the present invention, the encoder is made by: cutting a part of a cylindrical base material of a Fe—Cr—Co alloy which has been formed into a cylindrical shape, into a predetermined length in relation to the axial direction, to thereby make a first intermediate base material; subjecting this first intermediate base material to finishing to thereby make a second intermediate base material; and magnetizing this second intermediate base material with north poles and south poles alternately around the circumferential direction.

### BRIEF DESCRIPTION OF THE DRAWINGS

FIG. 1 is a cross-sectional view showing a first example of an embodiment of the present invention.

FIG. 2 is a half side view of an encoder seen from the right side of FIG. 1.

FIG. 3 illustrates a manufacturing method of an encoder incorporated into the first example of the embodiment of the present invention, in the order of steps.

FIG. 4 shows another example of an encoder similar to FIG. 2.

FIG. 5 is a cross-sectional view showing a second example of the embodiment of the present invention.

FIG. 6 is a half cross-sectional view showing a third example of the embodiment of the present invention.

FIG. 7 is a half cross-sectional view showing a fourth example of the embodiment of the present invention.

FIG. 8 is a cross-sectional view showing a fifth example of the embodiment of the present invention.

FIG. 9 is a cross-sectional view showing a sixth example of the embodiment of the present invention.

FIG. 10 is a half cross-sectional view showing a seventh example of the embodiment of the present invention.

FIG. 11 is a half cross-sectional view showing an eighth example of the embodiment of the present invention.

FIG. 12 is a partial cross-sectional view showing three examples of an encoder secured to a slinger.

FIG. 13 is a cross-sectional view showing a ninth example of the embodiment of the present invention.

FIG. 14 is a cross-sectional view showing a tenth example of the embodiment of the present invention.

FIG. 15 is a partial cross-sectional view showing three examples of an encoder secured to a slinger constituting a combination seal ring.

FIG. 16 is a cross-sectional view showing an eleventh example of the embodiment of the present invention.

FIG. 17 is a perspective view of the encoder incorporated into the eleventh example of the embodiment of the present invention.

FIG. 18 illustrates a manufacturing method of the encoder incorporated into the eleventh example of the embodiment of the present invention, in the order of steps.

FIG. 19 is a cross-sectional view showing a twelfth example of the embodiment of the present invention.

FIG. 20 is a half cross-sectional view showing a thirteenth example of the embodiment of the present invention.

FIG. 21 is a half cross-sectional view showing a fourteenth example of the embodiment of the present invention.

FIG. 22 is a cross-sectional view showing a fifteenth example of the embodiment of the present invention.

FIG. 23 is a cross-sectional view showing a sixteenth example of the embodiment of the present invention.

FIG. 24 is a cross-sectional view showing a seventeenth example of the embodiment of the present invention.

FIG. 25 is a cross-sectional view showing an eighteenth example of the embodiment of the present invention.

FIG. 26 is a cross-sectional view showing an example of a conventional construction.

### BEST MODE FOR CARRYING OUT THE INVENTION

A rolling bearing unit with an encoder according to the present invention, similarly to the aforementioned conventionally-known rolling bearing unit with an encoder, comprises; an outer ring, an inner ring unit, a plurality of rolling elements, and an encoder.

The outer ring has a double-row outer ring raceway on an inner peripheral surface.

The inner ring unit has a double-row inner ring raceway on an outer peripheral surface, and is arranged concentric with the outer ring on the inner diameter side of the outer ring.

The plurality of rolling elements are rotatably provided respectively between the inner ring raceway and the outer ring raceway.

The encoder is fixed to a rotating member, being a bearing ring member of one of the outer ring and the inner ring unit which rotates during use, and on the encoder north poles and south poles are arranged alternately around the circumferential direction.

Particularly, in the rolling bearing unit with an encoder of the present invention, the encoder is formed from a Fe—Cr—Co magnet.

In the manufacturing method of a rolling bearing unit with an encoder according to the present invention, the encoder is formed in the following steps.

Firstly, a part of a cylindrical base material of a Fe—Cr—Co alloy which has been formed into a cylindrical shape, is cut into a predetermined length in relation to the axial direction, to thereby make a first intermediate base material.

Next, this first intermediate base material is subject to finishing such as grinding and cutting, to thereby make a second intermediate base material.

Then, this second intermediate base material is magnetized with north poles and south poles alternately around the circumferential direction.

According to the rolling bearing unit with an encoder and the manufacturing method thereof of the present invention constituted as described above, since the encoder is formed from a Fe—Cr—Co magnet, then different from the aforementioned rubber magnet mixed with ferrite powder, the magnetic properties do not become uneven depending on the position on the encoder. Consequently, the rotational speed of the wheel can be detected with higher accuracy (ensuring sufficient reliability).

Hereunder is a description of an embodiment of the present invention, with reference to the drawings.

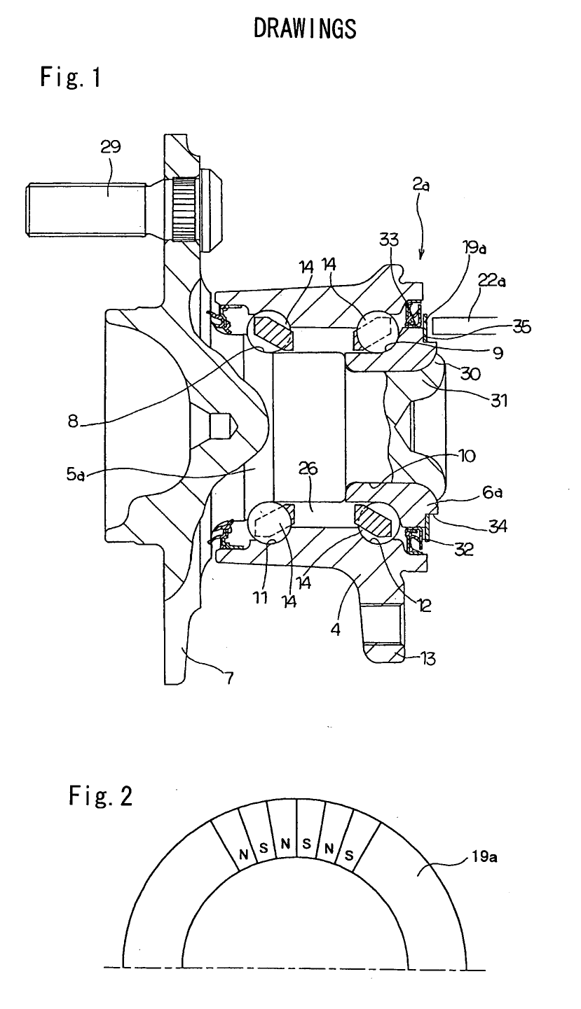

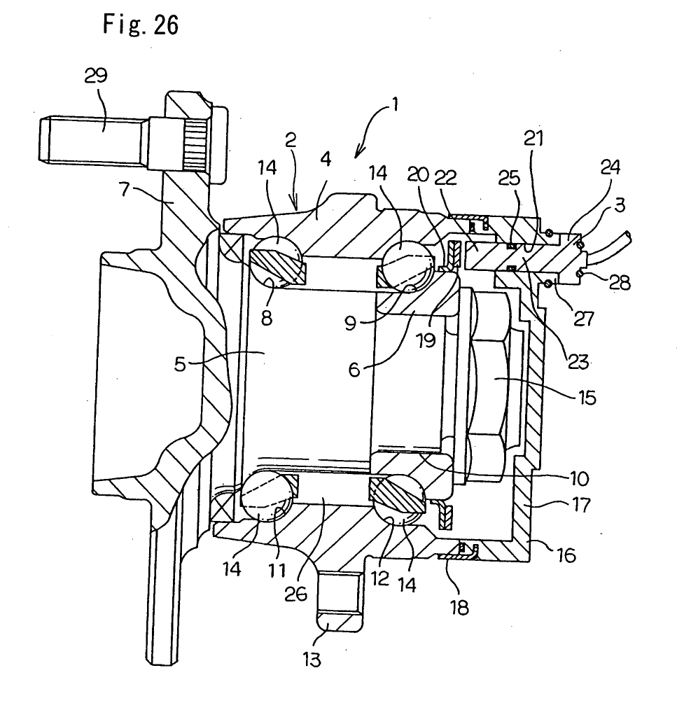

FIG. 1 and FIG. 2 show a first example of the embodiment of the present invention. The present invention is characterized in the point that an encoder 19a is made from a Fe—Cr—Co (iron chrome cobalt) magnet, so that a rotation detecting sensor 22a can detect the rotational speed with high accuracy. The constitution and the function of other parts are substantially similar to those in FIG. 26 mentioned above. Therefore the same reference symbols are used for components the same or equivalent to those in FIG. 26, and duplicate description is omitted or simplified. Hereunder, the description is centered on parts characteristic of the present invention and parts different from the structure of FIG. 26.

Differing from the structure of FIG. 26 mentioned above, in the rolling bearing unit 2a of the present example, the inner ring 6a which is externally fitted to the step portion 10 on the inside end of the hub 5a, is held in by a crimped portion 30 to prevent the inner ring 6a from coming away from the step portion 10. That is, the crimped portion 30 is formed by plastically deforming radially outward a cylinder portion 31 which is provided axially inward with respect to the inside end surface of the inner ring 6a, on the inside end of the hub 5a, so that the inside end surface of the inner ring 6a is held in by the crimped portion 30. Moreover, between the outer peripheral surface of the inside end of the inner ring 6a and the inner peripheral surface of the inside end of the outer ring 4 is closed by a seal ring 32. Therefore, in the present example, the cover 16 is not provided over the inside end of the outer ring 4, such as in FIG. 26.

Moreover, on the outer peripheral surface of the inner ring 6a, axially inward with respect to a cylinder surface 33 where the seal ring 32 is provided, is formed a step portion 34 having a smaller diameter than that of the cylinder surface 33. The step portion 34 is formed concentric with the hub 5a and the inner ring 6a. Furthermore, a step face 35 which connects between the step portion 34 and the cylinder surface 33, is formed perpendicularly with respect to the rotation axis of the hub 5a and the inner ring 6a. The step portion 34 and the step face 35 are accurately processed by turning or the like. That is, the step portion 34 is formed so as to improve the parallelism with respect to the rotation axis of the hub 5a, and the step face 35 is formed so as to improve the perpendicularity with respect to the rotation axis of the hub 5a.

Particularly, in the case of the present example, the encoder 19a is formed from a Fe—Cr—Co magnet. That is, in the case of the present example, the encoder 19a is not made from a rubber magnet such as in the conventional construction shown in FIG. 26, but is made from a Fe—Cr—Co magnet which is a magnetized Fe—Cr—Co alloy. Moreover, in the case of the present example, the encoder 19a is formed into an annular shape as shown in FIG. 2. Also in the case of the present example, the inner peripheral rim of the encoder 19a is externally fitted to the step portion 34, and the part near the inner peripheral rim on the outside surface of the encoder 19a is contacted with the step face 35, so that the encoder 19a is secured to the inner ring 6a. The step portion 34 and the step face 35 are accurately processed as described above. Therefore with the encoder 19a in the secured condition, the encoder 19a is supported concentric with the hub 5a and the inner ring 6a, and surface run-out of the encoder 19a (axial displacement of the surface to be detected) is suppressed.

In the case of the present example, of the two side surfaces of the encoder 19a, the surface contacted with the magnetizing member during the magnetizing operation (the magnetized surface and also the surface to be detected) is smoothened. Specifically, the surface roughness of this magnetized surface is made 0.2 μm or less by center line average height roughness Ra. That is, since the Fe—Cr—Co magnet is superior in workability, the dimensional accuracy of the encoder 19a can be improved by applying the finishing described later. If in this manner the magnetized surface of the encoder 19a can be smoothened, corrugations in the micro scales on the magnetized surface can be reduced to a minimum, enabling accurate magnetization of the encoder 19a (reducing the pitch error or the like to an insignificant level).

As described above, the rotation detecting sensor 22a is provided in a position axially facing the inside surface of the encoder 19a which is externally fitted to the step portion 34. The rotation detecting sensor 22a is secured to a part of the suspension system (not shown), and the tip end surface, being the detection surface, is arranged to face the inside surface, being the surface to be detected, of the encoder 19a. Moreover, the rotation detecting sensor 22a is an active type comprising; a magnetic detecting element such as a hall element, or a magnetoresistance element, for which the characteristics change according to changes in the magnetic flux flowing out from a permanent magnet, and a waveform shaping circuit for shaping the waveform (making into a rectangular wave) of the output signals from this magnetic detecting element. Such an active type rotation detecting sensor 22a is used in a condition with a predetermined voltage applied to the magnetic detecting element from a separate power source (for example, a battery in the engine compartment). A passive type may also be used as the rotation detecting sensor 22a. However in order to detect the rotational speed with high accuracy (ensuring sufficient reliability) during low-speed traveling, the active type is preferably used.

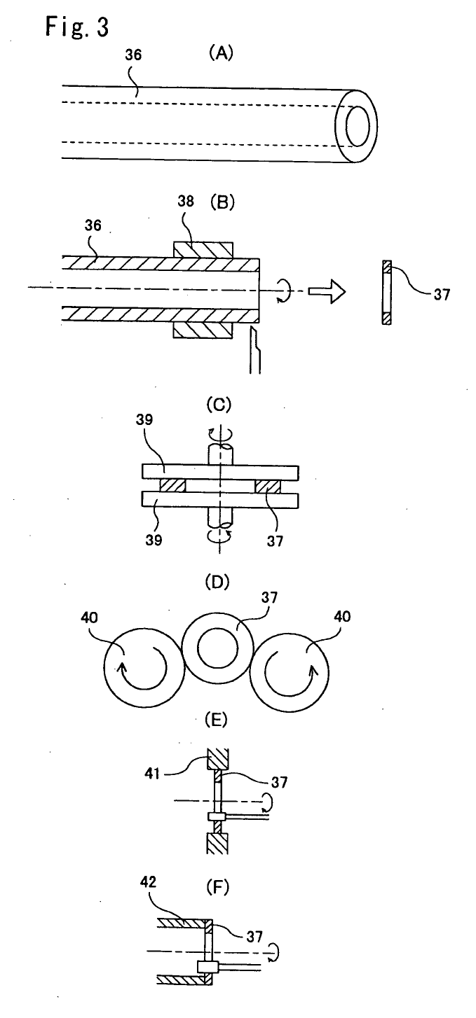

In the case of the present example, the encoder 19a is manufactured in the following steps in order to process the encoder 19a with excellent dimensional accuracy as described above. Firstly, as shown in FIG. 3(A), a cylindrical base material 36 made from a Fe—Cr—Co alloy which has been formed into a cylindrical shape, is obtained. Such a cylindrical base material 36 can be readily obtained by continuous extrusion molding. Then, as shown in FIG. 3(B), a part of the cylindrical base material 36 is cut into a predetermined length, which is then used as a first intermediate base material 37. The cylindrical base material 36 has sufficient axial length with respect to the axial thickness of the encoder 19a. Moreover the wall thickness in the radial direction is made slightly thicker than for the radial width of the encoder 19a. At the time of manufacturing the first intermediate base material 37, a part of the cylindrical base material 36 is secured by a chuck 38. Then the end portion of the cylinder base member 36 is cut to a predetermined axial length (a length slightly greater than the axial thickness of the encoder 19a) by a tool such as a cutting tool, and is then used as the first intermediate base material 37.

Next, as shown in FIG. 3(C) to FIG. 3(E), the first intermediate base material 37 is subject to finishing, and is then used as a second intermediate base material. That is, the both side faces of the first intermediate base material 37 are ground by grindstones 39 as shown in FIG. 3(C), and the outer peripheral surface of the first intermediate base material 37 is ground by grindstones 40 as shown in FIG. 3(D). Furthermore, as shown in FIG. 3(E), the outer peripheral surface of the first intermediate base material 37 is gripped by a chuck 41, to grind the inner peripheral surface of the first intermediate base material 37. The order of grinding the both side faces, and grinding the inner and outer peripheral surfaces is of no importance. As shown in FIG. 3(F), in order to grind the inner peripheral surface of the first intermediate base material 37, the side surface of the first intermediate base material 37 may be magnetically attached by a magnet chuck 42 to support the first intermediate base material 37. By applying such finishing, the second intermediate base material having the desired shape and dimension for the encoder is made. Then this second intermediate base material is magnetized with north poles and south poles arranged alternately at equal intervals around the circumferential direction, so as to obtain the encoder 19a shown in FIG. 2. The magnetization direction of the second intermediate base material is oriented perpendicular to the side face of the second intermediate base material.

As described above, if the encoder 19a is formed from the cylindrical base material 36, the dimensional accuracy of the encoder 19a can be improved and the yield of the base material can be increased. That is, since the parent material of the encoder 19a is the cylindrical base material 36, the cylindrical base material 36 can be firmly held by the chuck 38 when the end of the cylindrical base material 36 is cut. Therefore, errors caused during this cutting operation can be reduced. On the other hand, if the parent material of the encoder 19a is plate-shape, it is difficult to grip when processing into a predetermined shape, and errors caused during this processing operation are readily increased. Moreover, the yield of the material is decreased. Consequently, as with the present example, by making the parent material for obtaining the encoder 19a the cylindrical base material 36, the encoder 19a can be manufactured with excellent dimensional accuracy at low cost. In the case of the present example also, plate-shaped first and second intermediate base materials are held at the time of finishing. However at this time, the force applied to the intermediate base materials is relatively small, so that errors caused during the processing are almost negligible.

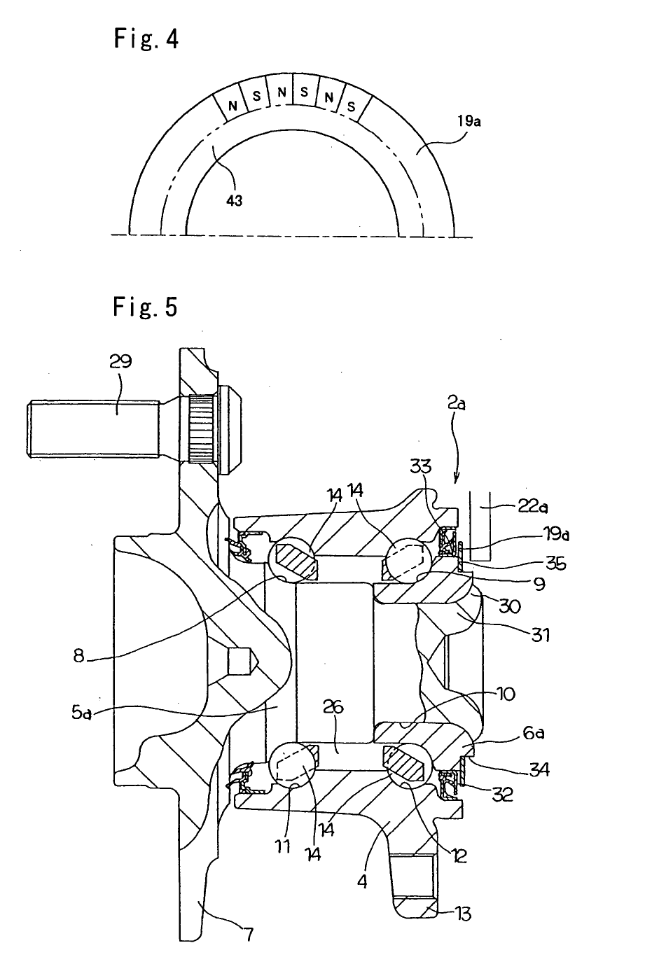

In the aforementioned magnetizing operation of the encoder 19a, if the part at the inner peripheral rim portion of the encoder 19a, which is in contact with the inner ring 6a, is not magnetized, then when the encoder 19a is externally fitted to the step portion 34 which is formed on the outer peripheral surface of the inner ring 6a, it is possible to reduce the degree of effect on the variation of the magnetic flux density of the encoder 19a by the inner ring 6a. That is, since the inner ring 6a is made from steel, if the encoder 19a is magnetized overall, the part of the encoder 19a in contact with the step face 35 of the inner ring 6a has a greater magnetic flux density compared to a part not in contact (a lot of magnetic flux flows through the part in contact). Conversely speaking, in the case where the magnetic flux density of the part not in contact with the step face 35 is reduced, and the detection element of the sensor is arranged to face this part not in contact, it becomes difficult to ensure the detection accuracy (reliability). On the other hand, if as shown in FIG. 4, the part at the inner peripheral rim portion of the encoder 19a, which contacts with the step portion 34 and the step face 35 of the inner ring 6a when the encoder 19a is externally fitted to the inner ring 6a, is a non magnetized portion 43, it becomes possible to ensure the magnetic flux density of the part not in contact with the step face 35, and to detect the rotational speed with higher accuracy (ensuring sufficient reliability).

In the case of the present example constituted as described above, since the encoder 19a is formed from the Fe—Cr—Co magnet, it is possible to reduce the unevenness of the magnetic properties of the encoder 19a, and to detect the rotational speed of the wheel with high accuracy (ensuring sufficient reliability). That is, regarding the Fe—Cr—Co magnet, different to the rubber magnet as mentioned above where a ferrite powder is mixed in the rubber, the magnetic properties do not readily become uneven depending on the position on the encoder 19a. Therefore, the encoder 19a in the present example can obtain an accurate waveform of the magnetic flux variation, and it becomes possible to detect the rotational speed with high accuracy. Moreover, in the present example, as described above, by smoothening the magnetized surface of the encoder 19a, the magnetic accuracy can be improved. Therefore the waveform of the magnetic flux variation of the encoder 19a can be obtained more accurately and the detection accuracy of the rotational speed can be further improved.

Next, FIG. 5 shows a second example of the embodiment of the present invention. In the structure of the aforementioned first example, the rotation detecting sensor 22a is arranged in the axial direction of the rolling bearing unit, and the axial end surface of the rotation detecting sensor 22a is arranged to face the encoder 19a. On the other hand, in the case of the present example, the rotation detecting sensor 22a is arranged in the radial direction of the rolling bearing unit, and the tip side surface of the rotation detecting sensor 22a is arranged to face the inside surface of the encoder 19a. Therefore, in the case of the present example, the tip outside surface of the rotation detecting sensor 22a becomes the detection surface. Other structure and operation are similar to in the first example mentioned above.

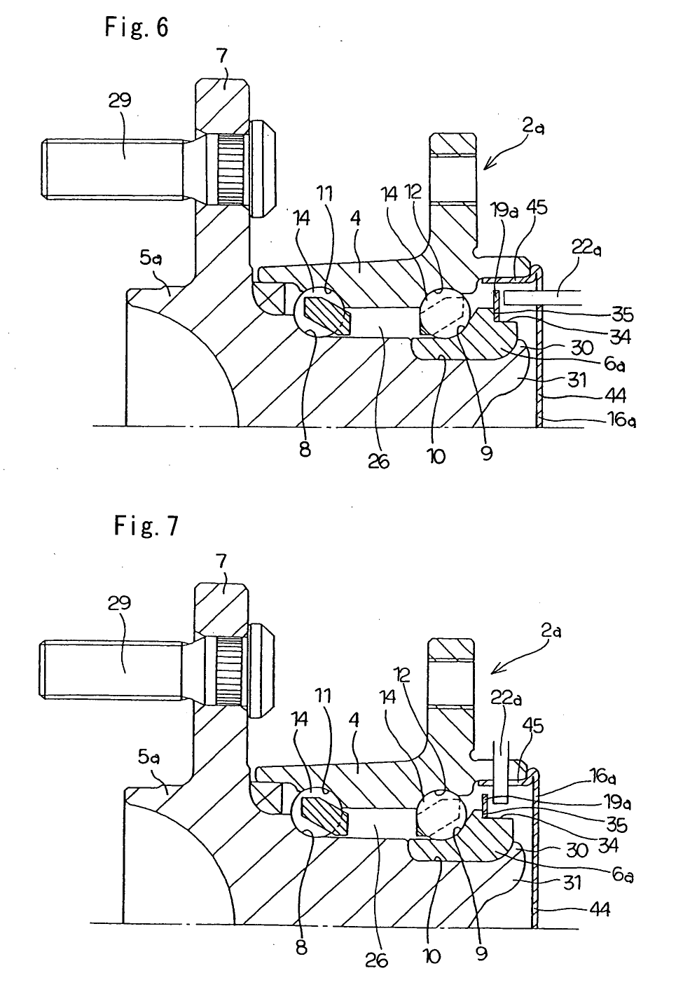

Next, FIG. 6 shows a third example of the embodiment of the present invention, and FIG. 7 shows a fourth example of the embodiment of the present invention. In the structure of these third and fourth examples, a cover 16a is provided over the inside end of the rolling bearing unit 2a. Therefore, the seal ring 32 (FIG. 1 and FIG. 5) between the inner peripheral surface of the inside end of the outer ring 4 and the outer peripheral surface of the inside end of the inner ring 6a is omitted, which is different from the structure of the aforementioned first example and second example. The cover 16a is formed by bending a disc-shaped member such as a mild steel plate. That is, a cylinder portion 45 is made by bending the outer peripheral rim of a disc 44 axially outward. Then, the cylinder portion 45 is secured to the inner surface of the inside end of the outer ring 4, so that the inside end opening of the outer ring 4 is closed. The cover 16a may be made from a synthetic resin such as shown in FIG. 26 mentioned above. In the case of the structure of FIG. 6, the rotation detecting sensor 22a is inserted from a through hole provided at one location around the circumferential direction of the disc 44, so that the tip end surface of the rotation detecting sensor 22a which is arranged in the axial direction of the rolling bearing unit, faces the inside surface of the encoder 19a. On the other hand, in the case of the structure of FIG. 7, the rotation detecting sensor 22a is inserted radially through the inside end of the outer ring 4, so that the tip outside surface of the rotation detecting sensor 22a which is arranged in the radial direction of the rolling bearing unit, faces the inside surface of the encoder 19a. Other structure and operation are similar to in the first example mentioned above.

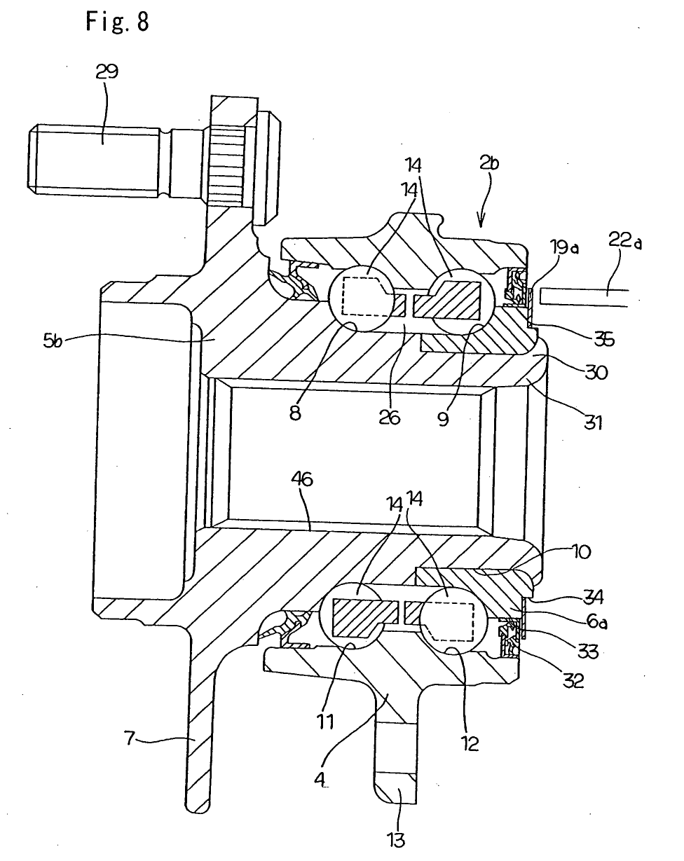

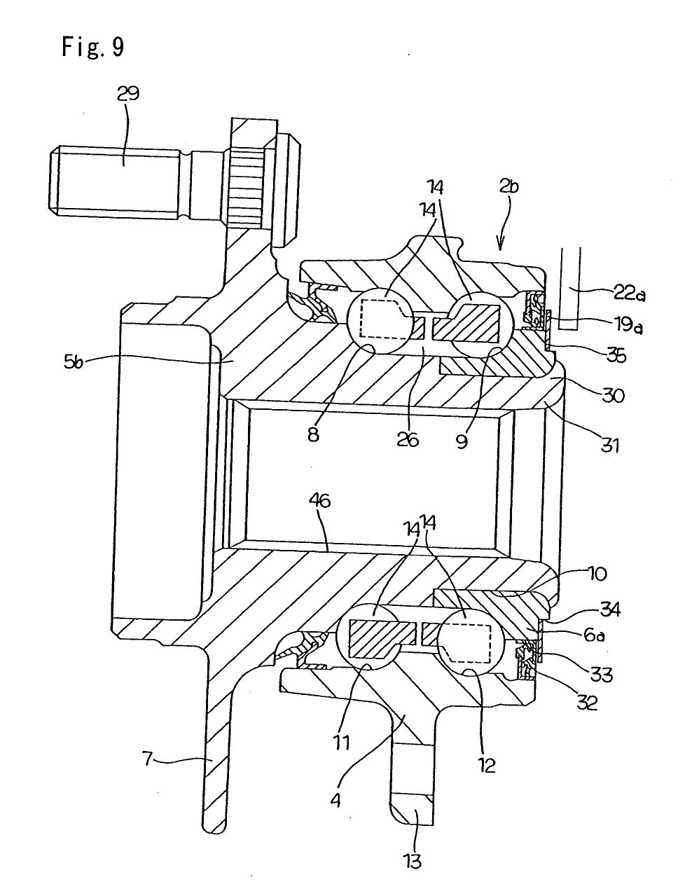

Next, FIG. 8 and FIG. 9 respectively show a fifth example and a sixth example of the embodiment of the present invention. The structure of these fifth and sixth examples shows a case where the present invention is applied to a driving wheel rolling bearing unit 2b. Therefore, a spline hole 46 is provided in the center of a hub 5b constituting the rolling bearing unit 2b. This spline hole 46 is spline-engaged with a spline shaft provided on the outside end of a constant velocity joint (not shown). Other structure and operation are similar to in the first example mentioned above.

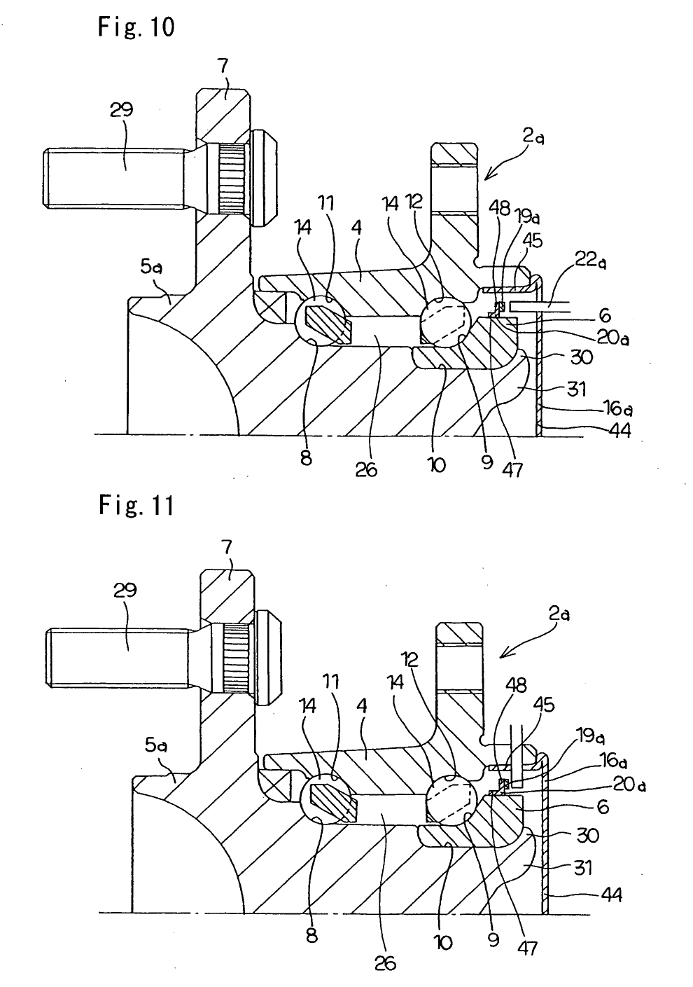

Next, FIG. 10 shows a seventh example of the embodiment of the present invention, and FIG. 11 shows an eighth example of the embodiment of the present invention. In the structure of these seventh and eighth examples, the step portion 34 (refer to FIG. 1, FIG. 5, and FIG. 9) is not provided on the inside end of the inner ring 6, which is different from the aforementioned examples. Instead, an encoder 19a is fixed to the outer peripheral surface of the inside end of the inner ring 6 via a slinger 20a. This slinger 20 is formed into an overall annular shape of L-shape in cross-section by bending a magnetic metal plate of a carbon steel plate such as SPCC, and comprises a cylinder portion 47, and an annular portion 48 where the inside end of the cylinder portion 47 is bent radially outward. Moreover, the encoder 19a is bonded onto the inside surface of the annular portion 48 by magnetic attraction, adhesion, or the like. Other structure and operation are similar to in the third example and the fourth example mentioned above.

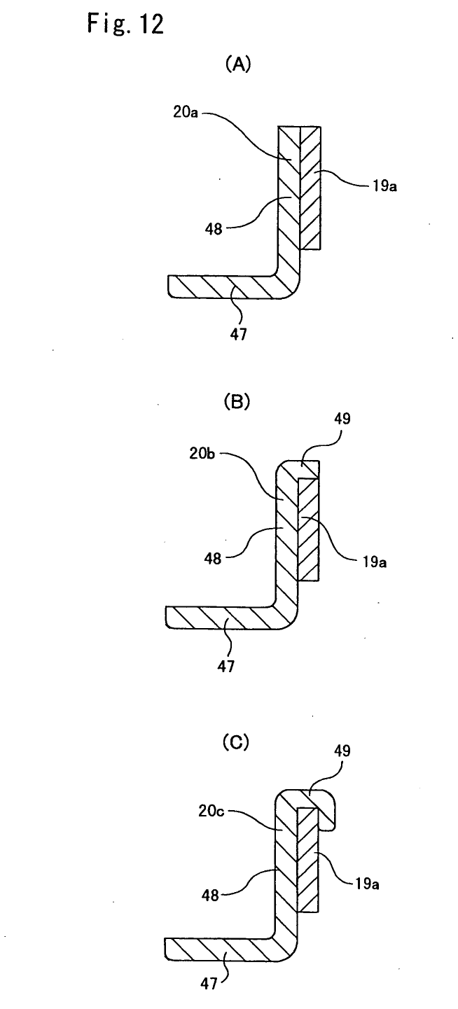

The structure shown in FIG. 12 can be employed as a structure for fixing the encoder 19a to the slinger 20a. In FIG. 12(A), the encoder 19a is simply bonded to the annular portion 48 as shown in FIG. 10 and FIG. 11. Moreover, in FIG. 12(B), the slinger 20b has an outer cylinder portion 49 where the outer peripheral rim of the annular portion 48 is bent axially inward, and the outer peripheral rim of the encoder 19a is contacted with or adjacently faces the inner peripheral surface of the outer cylinder portion 49. If the outer peripheral rim of the encoder 19a is contacted with the inner peripheral surface of the outer cylinder portion 49 in this manner, the encoder 19a can be readily fixed to the slinger 20b in a concentric manner. Furthermore, in FIG. 12(C), the whole circumference or a plurality of parts around the circumferential direction of the axial inside end of the outer cylinder portion 49 of the slinger 20c is crimped radially inward, so that the outer peripheral rim of the encoder 19a is secured to the slinger 20c. As a result, the encoder 19a can be secured to the slinger 20c more reliably.

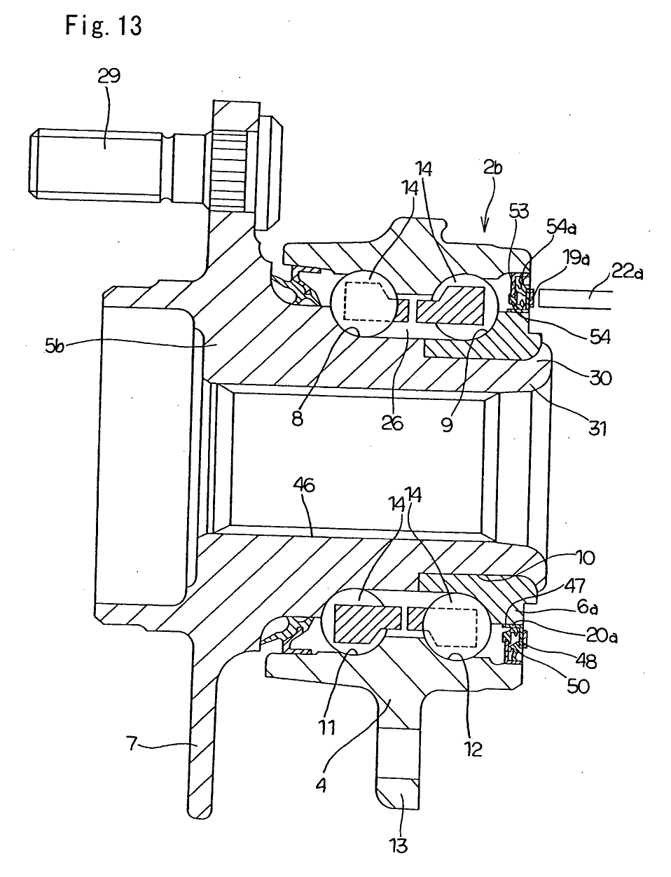

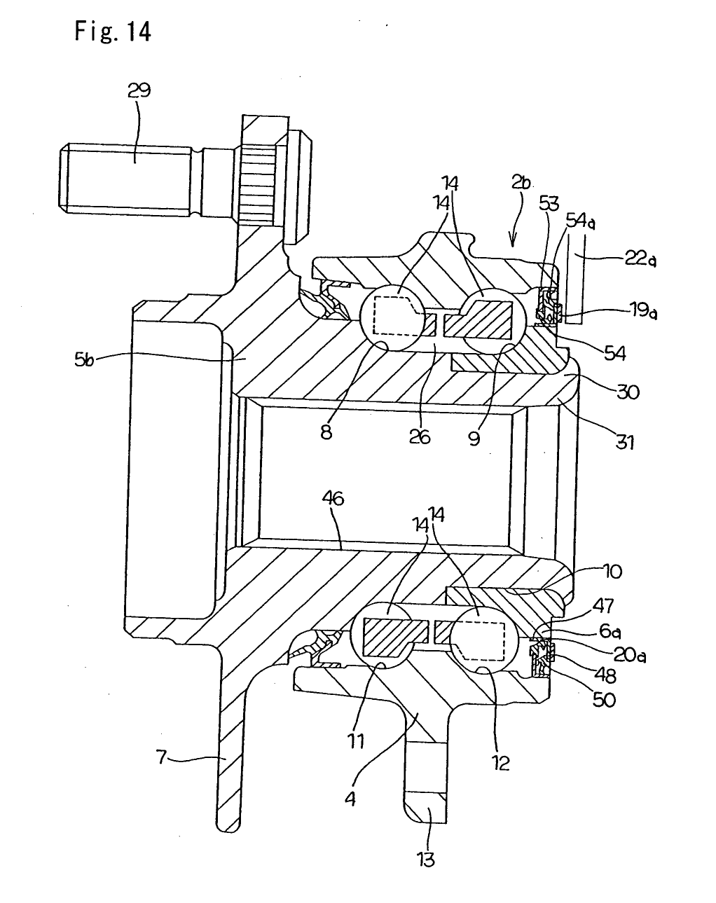

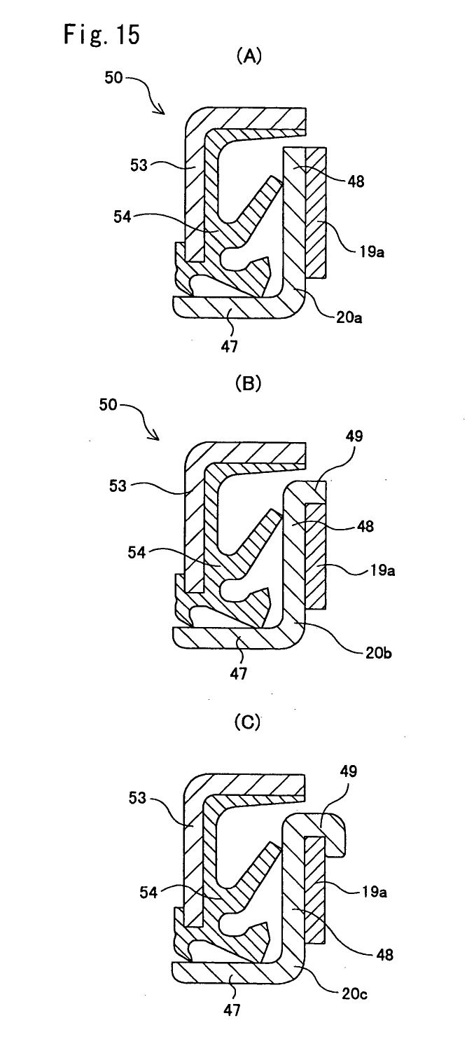

Next, FIG. 13 shows a ninth example of the embodiment of the present invention, and FIG. 14 shows a tenth example of the embodiment of the present invention. In the structure of these ninth and tenth examples, a seal ring 50 is provided on the inside end of the driving wheel rolling bearing unit 2b. The encoder 19a is provided on the inside surface of the slinger 20a constituting the seal ring 50. The seal ring 50 comprises the slinger 20a, a core metal 53, and elastomers 54 and 54a which are bonded to the slinger 20a and the core metal 53 respectively around the whole periphery thereof. Moreover, in a condition with the slinger 20a externally fitted to the outer peripheral surface of the inside end of the inner ring 6a, and the core metal 53 internally secured to the inner peripheral surface of the inside end of the outer ring 4, a plurality of seal lips formed on the elastomers 54 and 54a are slidingly contacted with the surfaces of the slinger 20a and the core metal 53 respectively. Moreover, for the shape of this slinger 20a, similarly to the aforementioned FIG. 12(A) to FIG. 12(C), the shape of the respective slingers 20a and 20b as shown in FIG. 15(A) to FIG. 15(C) may be employed. In the structure shown in FIG. 15(A) to FIG. 15(C), the elastomer 54 is provided only on the core metal 53 side. Other structure and operation are similar to in the fifth example and the sixth example mentioned above.

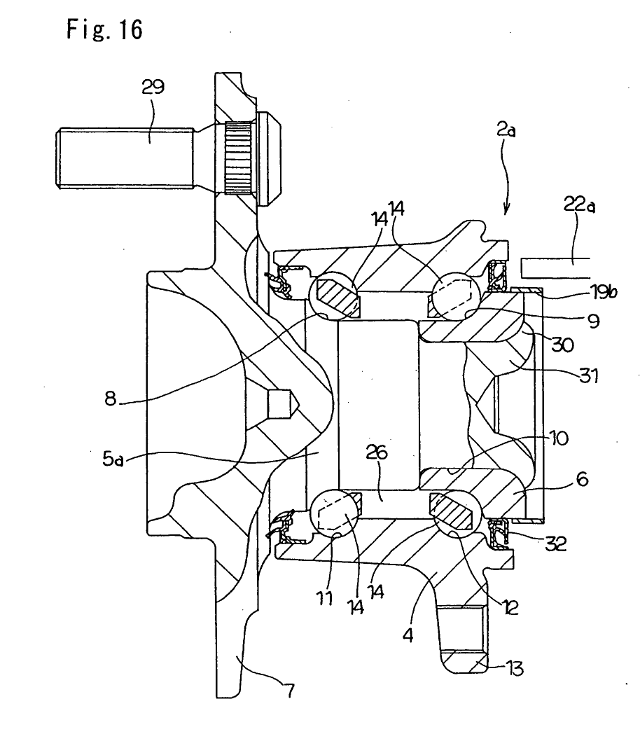

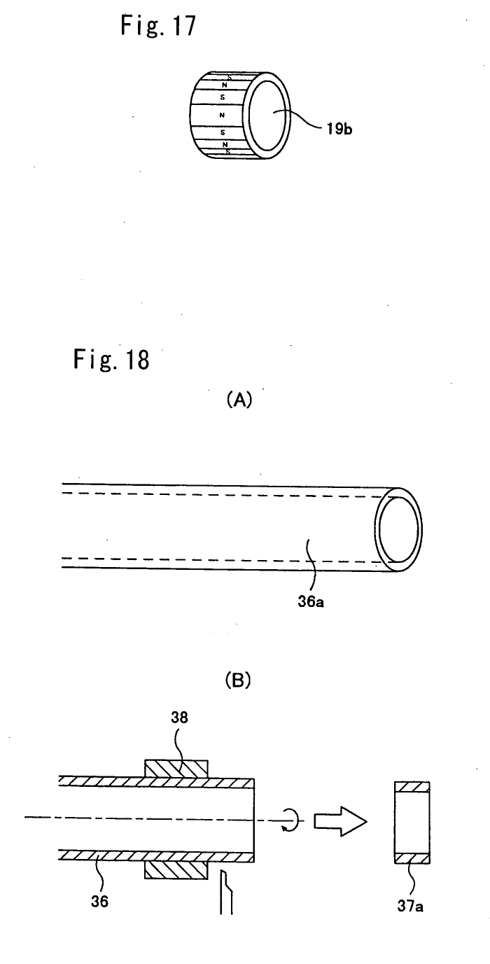

Next, FIG. 16 and FIG. 17 show an eleventh example of the embodiment of the present invention. In the structure of the present example, an encoder 19b is formed into a cylindrical shape. Furthermore, as shown in FIG. 17, north poles and south poles are arranged alternately at equal intervals around the circumferential direction on the outer peripheral surface of the encoder 19b. In the present example, the inner peripheral surface of the outside end of the encoder 19b having such a structure is externally fitted to the outer peripheral surface of the inside end of the inner ring 6. Moreover, in the structure of the present example, the rotation detecting sensor 22a is arranged radially outer side of the encoder 19b along the axial direction of the rolling bearing unit. The detecting element provided on the radial inner surface at the tip end of the rotation detecting sensor 22a, faces the outer peripheral surface of the encoder 19b.

In the case of the present example, the encoder 19b is manufactured in the following steps. That is, firstly, a cylindrical base material 36a as shown in FIG. 18(A) is formed from a Fe—Cr—Co alloy. The cylindrical base material 36a has sufficient axial length with respect to the axial length of the encoder 19b. Moreover the wall thickness is made slightly thicker than for the radial thickness of the encoder 19b. This cylindrical base material 36a has a wall thickness which is less than that of the cylindrical base material 36 shown in FIG. 3(A) mentioned above.

Next, as shown in FIG. 18(B), a part of such a cylindrical base material 36a is cut into a predetermined axial length (length slightly greater than the axial length of the encoder 19b by a tool such as a cutting tool, to give as a first intermediate base material 37a. Furthermore, as shown in FIG. 3(C) to FIG. 3 (F), the axial opposite end surfaces, the outer peripheral surface, and the inner peripheral surface of the first intermediate base material 37a are subject to grinding, to give a second intermediate base material having the predetermined shape and dimension. Then, this second intermediate base material is magnetized, so as to obtain the encoder 19b as shown in FIG. 17. The magnetization direction of the second intermediate base material is oriented perpendicularly to the tangent of the outer peripheral surface being the magnetized surface. That is, in the radial direction of the second intermediate base material formed into the cylindrical shape. Moreover, in the case of the present example, the magnetic accuracy can be also improved by smoothening the outer peripheral surface of the second intermediate base material being the magnetized surface. Other structure and operation are similar to in the first example mentioned above.

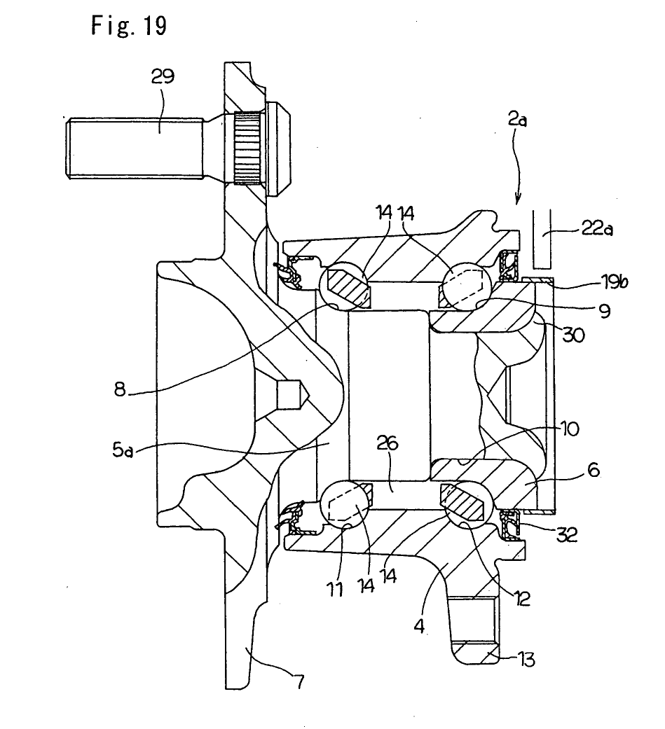

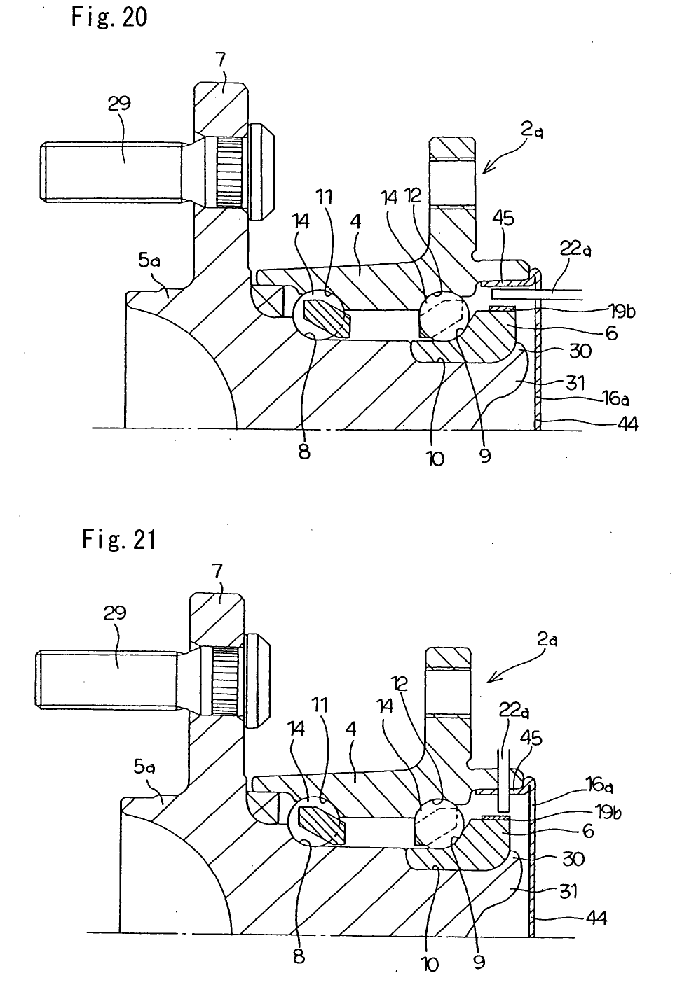

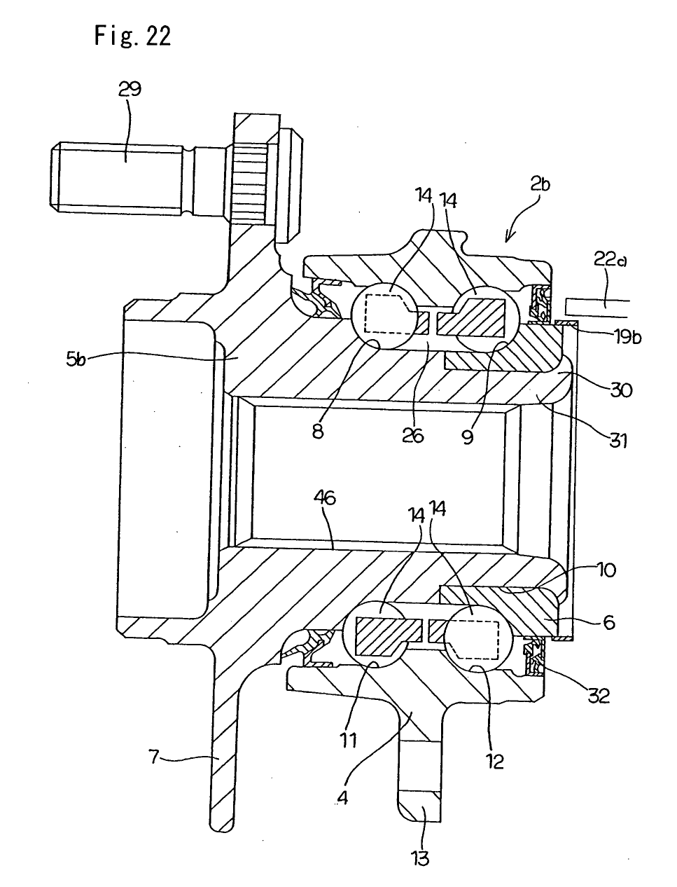

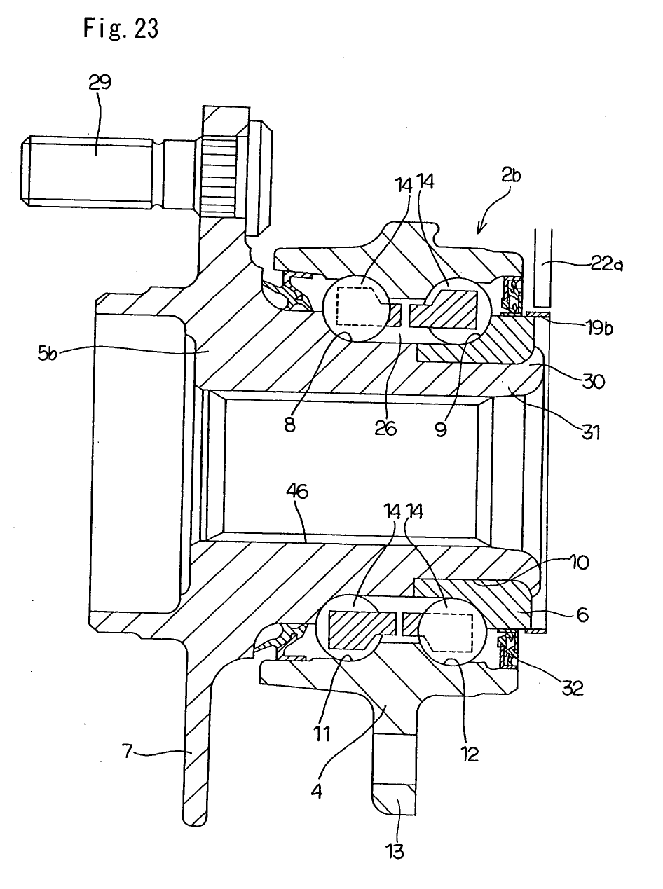

Next, FIG. 19 shows a twelfth example of the embodiment of the present invention. In the structure of the present example, the rotation detecting sensor 22a is arranged in the radial direction of the rolling bearing unit, which is different from the aforementioned eleventh example. The tip end surface of the rotation detecting sensor 22a faces the outer peripheral surface of the encoder 19b. Other structure and operation are similar to in the eleventh example mentioned above. Moreover FIG. 20 and FIG. 21 show, as thirteenth and fourteenth examples of the embodiment of the present invention, a case where the cylindrical encoder 19b is applied to the aforementioned structure shown in FIG. 6 and FIG. 7. Furthermore FIG. 22 and FIG. 23 show, as fifteenth and sixteenth examples of the embodiment of the present invention, a case where the cylindrical encoder 19b is applied to the aforementioned structure shown in the FIG. 8 and FIG. 9. Detailed structure and operation are as mentioned above.

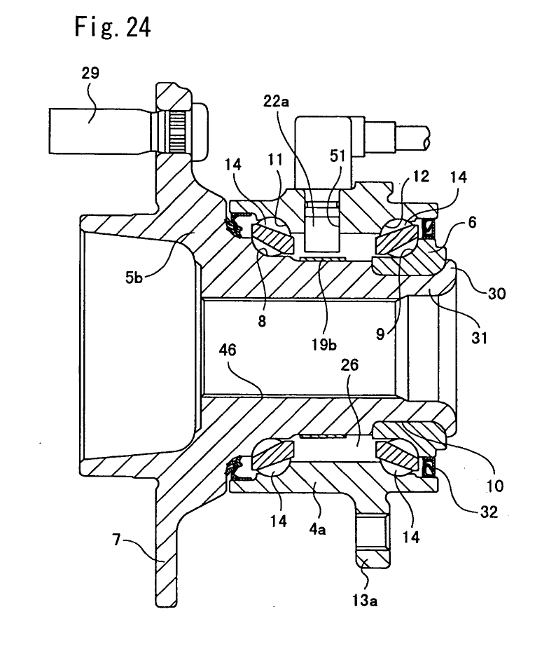

Next, FIG. 24 shows a seventeenth example of the embodiment of the present invention. In the structure of the present example, the encoder 19b is externally fitted to the outer peripheral surface of the middle portion of the hub 5b. That is, the encoder 19b formed in a cylindrical shape, is externally secured between the first inner ring raceway 8 formed on the outer peripheral surface of the hub 5b and the second inner ring raceway 9 formed on the outer peripheral surface of the inner ring 6. On the other hand, the rotation detecting sensor 22a is secured to the middle portion of the outer ring 4a at a position radially facing the encoder 19b. That is, a through hole 51 is formed in a part of the outer ring 4a, between the first outer ring raceway 11 and the second outer ring raceway 12 which are formed in positions respectively facing the first inner ring raceway 8 and the second inner ring raceway 9, in a condition piercing the outer ring 4a in the radial direction. In order to provide the through hole 51 in this manner, the formation position of the second flange 13a provided on the outer peripheral surface of the outer ring 4a for securing the outer ring 4a to the suspension system, is shifted axially inward.

Moreover, a rotation detecting sensor 22a is inserted into the through hole 51. The rotation detecting sensor 22a is installed at a position radially facing the encoder 19b. The installation direction of the rotation detecting sensor 22a is perpendicular to the tangent of the outer peripheral surface of the encoder 19b. Due to this configuration, even in the case where the hub 2b is tilted with respect to the outer ring 4a due to the moment from the wheel, the effect on the detection of the rotational speed can be reduced. Other structure and operation are similar to in the sixteenth example mentioned above.

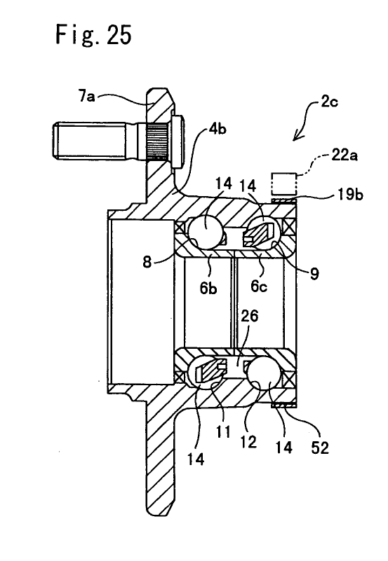

Next, FIG. 25 shows an eighteenth example of the embodiment of the present invention. In the structure of the present example, the rotating member is the outer ring 4b and the stationary member is the inner rings 6b and 6c. Therefore, the first flange 7a for securing the wheel is formed on the outer peripheral surface of the outside end of the outer ring 4b. In the operating condition of the rolling bearing unit 2c having such structure, the respective inner rings 6b and 6c are externally secured to the outer peripheral surface of the supporting shaft being a part of the suspension system (not shown), and the wheel is secured to the first flange 7a. That is, the wheel is rotatably supported about the supporting shaft via the rolling bearing unit 2c.

Moreover, in the case of the present example, the encoder 19b made from a Fe—Cr—Co magnet formed in a cylindrical shape, is externally secured to the inside end of the outer ring 4b. Therefore, a cylinder surface 52 with an outer peripheral surface formed in a cylindrical shape, is provided on the inside end of the outer ring 4b. Then the encoder 19b is externally secured to the cylinder surface 52. On the other hand, a rotation detecting sensor 22a is fixed to a part of the suspension system (not shown), and is arranged radially outer side of the encoder 19b. In the present example, the outer ring 4b rotates during use. Therefore, as mentioned above, the encoder 19b is externally fitted to the outer peripheral surface of the inside end of the outer ring 4b, so that the rotational speed of the wheel can be detected.

In the case where the present invention is applied to a rolling bearing unit of an outer ring rotation type as in the case of the eighteenth example, the structure may be such that a step portion is formed on the inner peripheral surface of the inside end of the outer ring, and the annular encoder is internally fitted to the step portion. That is, the encoder is internally fitted to the step portion which is formed on the inner peripheral surface of the inside end of the outer ring, and the outside peripheral rim of the outer surface of the encoder is contacted with a step face which connects between the step portion and a part having a smaller inner diameter than the step portion and existing axially outward from the step portion. Furthermore, if the structure is such that a part at the outside peripheral rim portion of the encoder which contacts with the outer ring, is not magnetized, the rotational speed can be detected with higher accuracy.

### INDUSTRIAL APPLICABILITY

Since the present invention is constructed and operated as described above, a rolling bearing unit with an encoder which detects the rotational speed of a wheel with high accuracy (ensuring sufficient reliability) is obtained. Therefore, it is possible to control an ABS or a TCS more accurately, contributing to an increase in the safety of automobiles.

1. A manufacturing method of an encoder, the method comprising the steps of:
(a) cutting a part of a cylindrical material of a metal alloy which has been formed into a cylindrical shape, and
(b) magnetizing the part of a cylindrical material with north poles and south poles alternately around a circumferential direction.
